(19) United States
(12) Patent Application Publication
(10) Pub. No.: US 2006/0145982 A1
(43) Pub. Date: Jul. 6, 2006

(54) METHOD AND APPARATUS FOR COMPENSATING GRAY-LEVEL LUMINANCE

(76) Inventor: Der-Yuan Tseng, Taoyuan County (TW)

Correspondence Address: ROBERT E. LOCKMAN, JR., 256 STATE ROAD 292 EAST, TUNKHANNOCK, PA, 18657, US

(21) Appl. No.: 10/907,650

(22) Filed: Apr. 11, 2005

(30) Foreign Application Priority Data
Jan. 6, 2005 (TW) 94100336

(51) Int. Cl. G09G 3/36

(52) U.S. Cl. 345/89

(57) ABSTRACT

A liquid crystal display having an apparatus for compensating gray-level luminance is provided. When an N-line inversion driving method is used for a liquid crystal display, the gray-level voltage of the first horizontal line with the same polarity is compensated. N gamma voltages are generated for the mth gray level and a multiplexer is used to select and output a proper voltage to the digital/analog converter. The multiplexer is controlled by a control signal. In positive polarity, the polarity control signal outputs a higher voltage during the period of the first horizontal line inversion. In negative polarity, the polarity control signal outputs a lower voltage during the period of the first horizontal line inversion.

### CROSS-REFERENCE TO RELATED APPLICATION

This application claims the priority benefit of Taiwan application serial no. 94100336, filed on Jan. 6, 2005.

### BACKGROUND OF THE INVENTION

1. Field of the Invention

The present invention relates to a display method of gray-level luminance and an apparatus thereof, and more particularly to a method and an apparatus of compensating gray-level luminance by a gray-level voltage when a liquid crystal display uses an N-line inversion driving method.

2. Description of the Related Art

With such advantages as light weight, thinness, flexible size, low operational voltage, low power consumption and non-radiation, liquid crystal display panels have taken the major trend in display panels in recent years.

In a liquid crystal display panel, the liquid crystal molecules cannot be kept under a specified polarity of a voltage, or after a while, liquid crystal molecules will be destroyed and cannot rotate with the variation of electrical fields even after the voltage is off. For a liquid crystal display panel, if an image displayed by a liquid crystal display panel is not changed, a voltage polarity applied to liquid crystal molecules should be changed to avoid destroying the properties of liquid crystal molecules. In the conventional driving method for a liquid crystal display panel, the polarity is changed by dividing the voltage difference between two ends of liquid crystal molecules to a positive voltage difference and a negative voltage difference. The method of changing polarity comprises a frame inversion method, a row inversion method, a column inversion method, and a dot inversion method. The difference among the methods described above is whether two neighboring pixels of the liquid crystal display panel have the same polarity. In these methods, the inversion of the polarity of each pixel synchronizes with the scanning of the whole image of the display panel. Without flicker and cross-talk issues, the dot inversion method is the most popular method.

In the conventional dot inversion method, a one-line inversion method, a two-line inversion method, and an N-line inversion method are developed. The polarity distribution and scanning waveform of the N-line inversion method can be inferred according to the polarity distribution and scanning waveform of the two-line inversion method.

FIG. 1 is a drawing showing a source driving circuit of a conventional liquid crystal display. The source driving circuit comprises a latch 100, a level shifter 102, a gamma resistor 104, a digital/analog converter 108, and an output buffer 110. Digital data are written in the latch 100. When the latch 100 stores image data of a horizontal line, the image data are transmitted to the level shifter 102. The level shifter 102 changes the voltage level of the digital image data and then outputs it to the digital/analog converter 108. The digital/analog converter 108 receives the digital image data and outputs an analog image data to the output buffer 110. Finally, the output buffer 110 writes the image data in liquid crystals. The output buffer 110 is composed of a unity-gain negative feedback operational amplifier.

The turn-on resistance of thin film transistors (TFTs) of the liquid crystal display panel is so high that the charging/discharging resistance-capacitance (RC) time delay of the pixels becomes great. FIG. 2 is a drawing showing charging/discharging a pixel capacitor of a liquid crystal display. The charging/discharging of the pixel capacitor cannot be reached immediately. As a result, an error voltage will occur so that the error voltage of the first horizontal line is higher than that of the other horizontal lines which have the same polarity. For a 1024×768 XGA liquid crystal display, the write time of a horizontal line is about 20 μs. If the time constant of each pixel is about 5 μs, 1.8% error voltage will be created. In a 110-V operational voltage, the error voltage is about 183 mV. For a high-resolution liquid crystal display, the horizontal-line becomes shorter, so the error voltage will be larger.

The combination of a traditional driving circuit and the N-line inversion driving method would have the following disadvantages.

1. In the traditional driving circuit, each gray level corresponds to a gamma resistor. As a result, each gray-level voltage is fixed.

2. When the N-line inversion driving method is adopted, the power can be saved. But the inversion of polarity does not occur until N-horizontal-line time, leading to the difference of charges of charging/discharging two neighboring horizontal lines. As a result, the display of the gray level is also different. When the whole display has the same gray level, bright/dark stripes will be shown on the display.

For a liquid crystal display panel, when the N-line inversion driving method is adopted, a driving circuit and a method to reduce the bright/dark stripes on the display are desired.

### SUMMARY OF THE INVENTION

Accordingly, the present invention is directed to a method of compensating gray-level luminance. The method can effectively resolve one or more issues caused by the limitation of the conventional technology.

The present invention provides a method of compensating gray-level luminance. The method is adapted for a liquid crystal display panel. The liquid crystal display panel comprises a plurality of data lines and a plurality of horizontal lines perpendicular to the data lines from top to bottom. Each data line comprises a plurality of pixels. Wherein, each pixel, according to the control signal provided by the data line, generates gray-level luminance corresponding thereto. The method of compensating gray-level luminance is by generating a plurality of gray-level voltages for selection corresponding to gray-level luminance. A voltage higher or lower than a target voltage can be selected to compensate the gray-level voltage when the charging/discharging time of the pixel is insufficient. The method of selecting the voltage can be controlled by a control signal.

According to the method of compensating the gray-level luminance in an embodiment of the present invention, when the pixels have the same gray level and the positive polarity, a control signal is provided to the pixel which does not have sufficient charging time. The control signal selects a high compensation gray-level voltage from multiple gray-level voltages. The high compensation gray-level voltage is determined by an error voltage.

According to the method of compensating the gray-level luminance of an embodiment of the present invention, when the pixels have the same gray level and the negative polarity, a control signal is provided to the pixel which does not have sufficient discharging time. The control signal selects a low compensation gray-level voltage from multiple gray-level voltages. The low compensation gray-level voltage is determined by an error voltage.

According to the method of compensating the gray-level luminance of an embodiment of the present invention, when two neighboring horizontal lines having a same polarity shows a same gray-level luminance, according to an error voltage between the two horizontal lines, one of the gray-level voltages is selected for compensation, and a first horizontal line of the two horizontal lines having the same polarity is compensated.

According to the method of determining the error voltage for compensating the gray-level luminance of an embodiment of the present invention, when plural horizontal lines have the same polarity, the error voltage is a voltage difference between a voltage of pixel capacitors of the first horizontal line and a voltage of pixel capacitors of the other horizontal lines after a same horizontal-line time.

According to the liquid crystal display having an apparatus for compensating gray-level luminance in an embodiment of the present invention, the liquid crystal display comprises a liquid crystal display panel, a voltage-dividing circuit, a control signal generator, a plurality of multiplexers, and a digital/analog converter. The liquid crystal display panel comprises a plurality of data lines and a plurality of horizontal lines perpendicular to the data lines from top to bottom. Each data line comprises a plurality of pixels, each pixel corresponds to one of the gray levels, and each pixel also corresponds to a polarity signal. The voltage-dividing circuit receives and divides a plurality of gamma voltages to generate a plurality of gray-level voltages corresponding to the luminance of each gray level. The control signal generator is coupled to the data lines, generating a control signal based on a polarity of the data lines. The multiplexers are coupled to the voltage-dividing circuit and the control signal generator, selecting one of the gray-level voltages for compensation based on the received control signal. The digital/analog converter is coupled to the multiplexers, receiving the gray-level voltages output from the multiplexers.

According to an embodiment of the present invention, a voltage-dividing circuit is provided. The voltage-dividing circuit comprises a plurality of voltage-dividing units connected in series, and each voltage-dividing unit is composed of a plurality of active or passive components.

According to an embodiment of the present invention, another voltage-dividing circuit is provided. N gray-level voltages corresponding to m gray levels are generated from m×n voltage-dividing units connected in series, and each voltage-dividing unit is composed of a plurality of passive or active components.

According to an embodiment of the present invention, a liquid crystal display having an apparatus for compensating gray-level luminance is provided. When the pixel corresponding to the gray-level luminance of the liquid crystal display has a positive polarity, the control signal generator controls each multiplexer so that each multiplexer selects a high gray-level voltage from the corresponding multiple gray-level voltages received by each multiplexer, and outputs the high gray-level voltage to the digital/analog converter for compensation.

According to an embodiment of the present invention, another liquid crystal display having an apparatus for compensating gray-level luminance is provided. When the pixel corresponding to the gray-level luminance of the liquid crystal display has a negative polarity, the control signal generator controls each multiplexer so that each multiplexer selects a low gray-level voltage from the corresponding multiple gray-level voltages received by each multiplexer, and outputs the low gray-level voltage to the digital/analog converter for compensation.

According to the driving method of compensating the gray-level luminance of the liquid crystal display in an embodiment of the present invention, a driving method for the liquid crystal display panel is an N-line inversion driving method, in which the polarity of N horizontal lines reverses once, and N is larger than, or equal to 2.

The above and other features of the present invention will be better understood from the following detailed description of the preferred embodiments of the invention that is provided in communication with the accompanying drawings.

### BRIEF DESCRIPTION OF THE DRAWINGS

FIG. 1 is a drawing showing a source driving circuit of a conventional liquid crystal display.

FIG. 2 is a drawing showing the charging/discharging of a pixel capacitor in a liquid crystal display.

FIG. 3 is a schematic drawing showing a source driving circuit according to an embodiment of the present invention.

FIG. 4A is a drawing showing a gamma resistor of a conventional source driving circuit.

FIG. 4B is a schematic drawing showing a gamma resistor of a source driving circuit according to an embodiment of the present invention.

FIG. 5A is a schematic drawing showing a circuit of compensating gray-level luminance in positive polarity according to an embodiment of the present invention.

FIG. 5B is a schematic drawing showing a circuit of compensating gray-level luminance in negative polarity according to an embodiment of the present invention.

FIG. 6A is a schematic drawing showing a gray-level compensation circuit in positive polarity coupled to a multiplexer according to an embodiment of the present invention.

FIG. 6B is a schematic drawing showing a gray-level compensation circuit in negative polarity coupled to a multiplexer according to an embodiment of the present invention.

FIG. 7 is a drawing showing a sequence of a control signal according to an embodiment of the present invention.

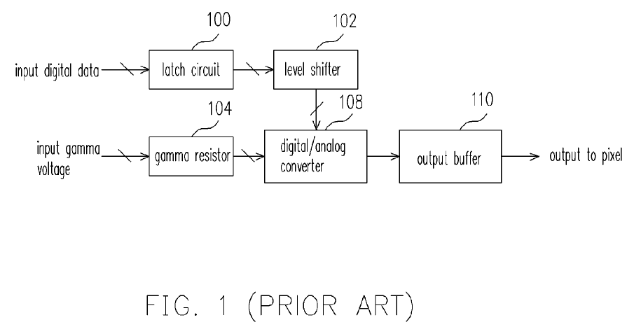

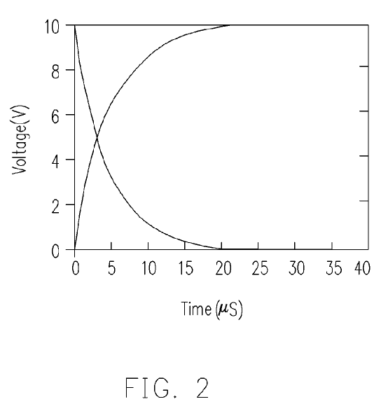

### DESCRIPTION OF SOME EMBODIMENTS

The features of the present invention will be described in the following embodiments accompanied with figures. The scope of the present invention, however, is not limited to these embodiments. Note that dimensions and ratios of these figures are not specified. Within the scope of the present invention, any structure and material described below can be appropriately modified.

In the traditional driving circuit accompanied with the dot inversion method, the polarities of two neighboring horizontal lines must be inversed. Though there is an error voltage in the charging/discharging voltage of the pixel, the error voltage displayed would not seem obvious in human eyes when the whole panel has the same gray level. As a result, the image on the display can be clearly seen.

In practice, the present invention does not require the dot inversion method. The present invention uses the N-line inversion driving method, which can save power. While using the N-line inversion driving method, accompanied with the method and apparatus for compensating the first gray-level voltage of the gray-level voltages with the same polarity.

The liquid crystal display panel comprises a plurality of data lines and a plurality of horizontal lines perpendicular to the data lines from top to bottom. The data lines have a plurality of pixels. Wherein, each pixel corresponds to a gray level and a polarity signal. In a conventional driving circuit accompanied with the N-line inversion method, the polarity is inversed once during an N-horizontal line time. Due to the properties of the circuit, two neighboring horizontal lines with the same polarity have different charges during charging/discharging. Therefore, in the N-line inversion driving method, the present invention provides a method of compensating the gray-level voltage of the first horizontal line of the gray-level voltages with the same polarity.

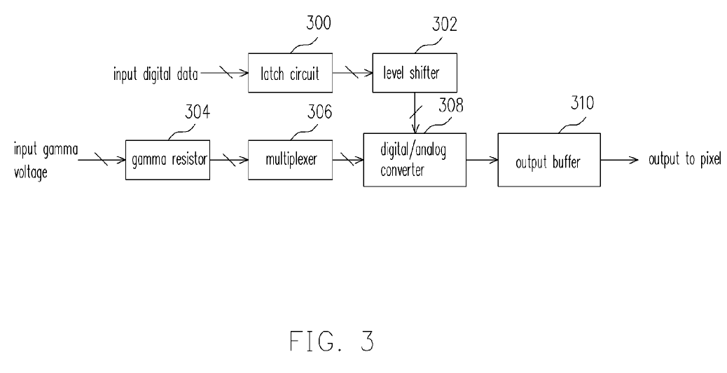

FIG. 3 is a schematic drawing showing a source driving circuit according to an embodiment of the present invention. The source driving circuit of the present invention comprises a latch 300, a level shifter 302, a gamma resistor 304, a multiplexer 306, a digital/analog converter 308, and an output buffer 310. Wherein, digital data are written in the latch 300. When the latch 300 stores image data of a horizontal line, the data are synchronously output to the level shifter 302. The level shifter 302 changes and outputs the voltage level of the digital image data to the digital/analog converter 308. The digital/analog converter 308 receives the digital image data and outputs an analog image data to the output buffer 310. The output buffer 310 then writes the image data in the liquid crystal pixels. Wherein, the output buffer 310 is composed of a unity-gain negative feedback operational amplifier.

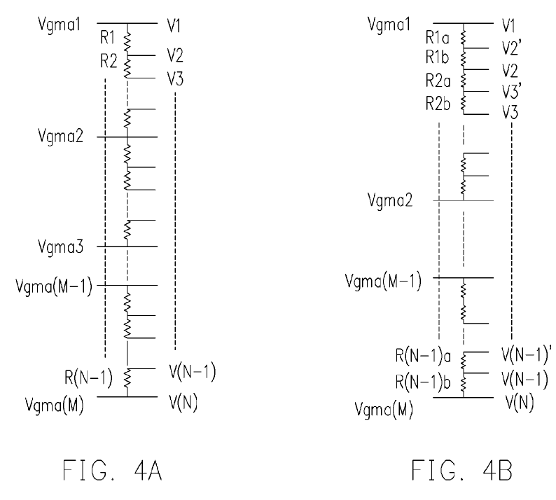

FIG. 4A is a drawing showing a gamma resistor of a conventional source driving circuit. FIG. 4B is a schematic drawing showing a gamma resistor of a source driving circuit according to an embodiment of the present invention. Referring to FIG. 4A, the present invention is an improvement from the system structure of the conventional source driving circuit. The gamma resistor of each gray level is divided into n resistors. FIG. 4B shows a gamma resistor where n=2. Comparing FIGS. 4A and 4B, the resistor R1 in FIG. 4A is equal to the resistors R1a+R1b in FIG. 4B; the resistor R2 in FIG. 4A is equal to the resistors R2a+R2b in FIG. 4B, and the resistor Rm in FIG. 4A Is equal to resistors Rma+Rmb in FIG. 4B, wherein m is an integer. In the N-line inversion process, m=2N−1. To achieve the purpose of compensation, the selection of the resistors Rma and Rmb is to allow the gray-level voltages of the two neighboring horizontal lines have the same polarity.

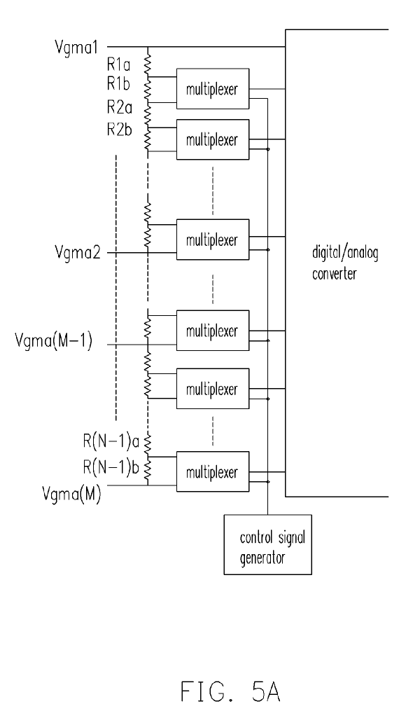

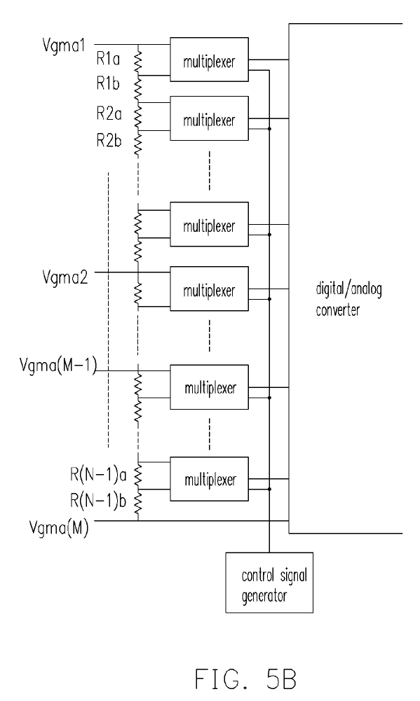

FIG. 5A is a schematic drawing showing a circuit of compensating a gray level in positive polarity according to an embodiment of the present invention. During the first-horizontal line time of inversing the polarity control signal, the control multiplexer 502 of the control signal generator 500 outputs a relatively high voltage. For the other horizontal-line times, the multiplexers 502 of the control signal generator 500 outputs a relatively low voltage.

FIG. 5B is a schematic drawing showing a circuit of compensating a gray level in negative polarity according to an embodiment of the present invention. During the first-horizontal line time of inversing the polarity control signal, the control multiplexer 512 of the control signal generator 510 outputs a relatively low voltage. For the other horizontal-line times, the multiplexers 512 of the control signal generator 510 outputs a relatively high voltage.

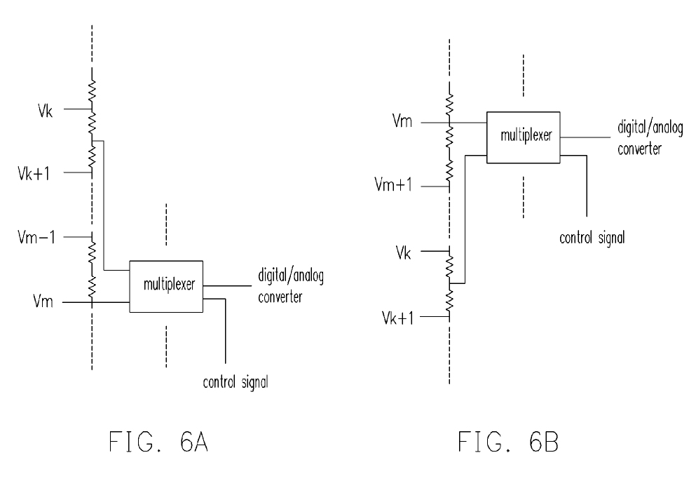

When two neighboring pixels with the same polarity have the same gray-level luminance, according to the difference of charges stored in capacitors of the two neighboring pixels, the error voltage Ve is generated to select the suitable gray-level voltage Vm, and to compensate the first horizontal line of the signals with the same polarity. Wherein, in the same horizontal-line write time, the error voltage Ve is the difference between the voltage of the first horizontal line and the voltage of the other horizontal lines. When the error voltage Ve is larger than the gray-level voltage difference between two neighboring gray levels, the dividing voltage Vk of the kth gray level is used to compensate the gray-level voltage of the first horizontal line with the same polarity. In the positive polarity, V(k+1)<Vm+Ve<Vk. FIG. 6A is a schematic drawing showing a gray-level compensation circuit with positive polarity coupled to a multiplexer according to an embodiment of the present invention. In the negative polarity, V(k+1)<Vm−Ve<Vk. FIG. 6B is a schematic drawing showing a gray-level compensation circuit with negative polarity coupled to a multiplexer according to an embodiment of the present invention.

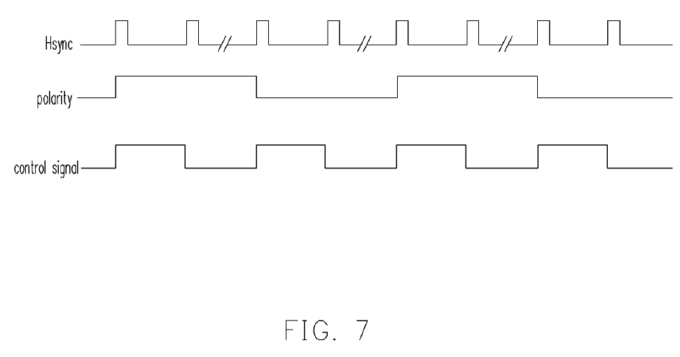

The luminance of each gray level corresponds to a multiplexer. The multiplexer selects one of the gray-level voltages to correspond to the gray-level luminance. The gray-level voltage is then output to the digital/analog converter. The multiplexer is controlled by a control signal generator. FIG. 7 is a drawing showing a sequence of a control signal according to an embodiment of the present invention. Accordingly, the first horizontal line with the same polarity can be selected for compensation.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

What is claimed is:

1. A method of compensating gray-level luminance, adapted for a liquid crystal display panel, the liquid crystal display panel comprising a plurality of data lines and a plurality of horizontal lines perpendicular to the data lines from top to bottom, each data line comprising a plurality of pixels, each data line providing a signal such that each pixel generates gray-level luminance corresponding thereto, the method of compensating gray-level luminance comprising:
generating a plurality of gray-level voltages corresponding to the gray-level luminance; and
receiving a control signal and selecting one of the gray-level voltages for compensation based on the control signal.

2. The method of compensating gray-level luminance of claim 1, wherein when the pixel corresponding to the gray-level luminance has a positive polarity, the control signal is provided to each pixel which does not have sufficient charging time, the control signal selects a high compensation gray-level voltage from the gray-level voltages, and the high compensation gray-level voltage is determined by an error voltage.

3. The method of compensating gray-level luminance of claim 1, wherein when the pixel corresponding to the gray-level luminance has a negative polarity, the control signal is provided to each pixel which does not have sufficient discharging time, the control signal selects a low compensation gray-level voltage from the gray-level voltages, and the low compensation gray-level voltage is determined by an error voltage.

4. The method of compensating gray-level luminance of claim 1, wherein when two neighboring horizontal lines having a same polarity shows a same gray-level luminance, according to an error voltage between the two horizontal lines, one of the gray-level voltages is selected for compensation, and a first horizontal line of the two horizontal lines having the same polarity is compensated.

5. The method of compensating gray-level luminance of claim 4, wherein when plural horizontal lines have the same polarity, the error voltage is a voltage difference between a voltage of pixel capacitors of the first horizontal line and a voltage of pixel capacitors of the other horizontal lines after a same horizontal-line time.

6. The method of compensating gray-level luminance of claim 1, wherein a driving method for the liquid crystal display panel is an N-line inversion driving method in which the polarity of N horizontal lines reverses once, and N is larger than, or equal to 2.

7. An apparatus of compensating gray-level luminance, adapted for a liquid crystal display panel, the liquid crystal display panel comprising a plurality of data lines and a plurality of horizontal lines perpendicular to the data lines from top to bottom, each data line comprising a plurality of pixels, each pixel corresponding to one of the gray levels, each pixel corresponding to a polarity signal, the apparatus of compensating gray-level luminance comprising:
a voltage-dividing circuit for receiving and dividing a plurality of gamma voltages to generate a plurality of gray-level voltages corresponding to the luminance of each gray level;
a control signal generator coupled to the data lines, generating a control signal based on a polarity of the data lines;
a plurality of multiplexers coupled to the voltage-dividing circuit and the control signal generator, receiving the control signal and selecting one of the gray-level voltages for compensation based on the control signal; and
a digital/analog converter coupled to the multiplexers, receiving the gray-level voltages output from the multiplexers.

8. The apparatus of compensating gray-level luminance of claim 7, wherein the voltage-dividing circuit comprises a plurality of voltage-dividing units connected in series, and each voltage-dividing unit is composed of a plurality of passive components.

9. The apparatus of compensating gray-level luminance of claim 7, wherein the voltage-dividing circuit comprises a plurality of voltage-dividing units connected in series, and each voltage-dividing unit is composed of a plurality of active components.

10. The apparatus of compensating gray-level luminance of claim 7, wherein a second number of the gray-level voltages corresponding to a first number of the gray levels are generated by multiplying the first number with the second number of voltage-dividing units in series, and each voltage-dividing unit is composed of a plurality of passive components.

11. The apparatus of compensating gray-level luminance of claim 7, wherein a second number of the gray-level voltages corresponding to a first number of the gray levels are generated by multiplying the first number with the second number of voltage-dividing units in series, and each voltage-dividing unit is composed of a plurality of active components.

12. The apparatus of compensating gray-level luminance of claim 7, wherein when the pixel corresponding to the gray-level luminance has a positive polarity, the control signal generator controls each multiplexer so that each multiplexer selects a high gray-level voltage from the gray-level voltages received by each multiplexer, and outputs the high gray-level voltage to the digital/analog converter for compensation.

13. The apparatus of compensating gray-level luminance of claim 7, wherein when the pixel corresponding to the gray-level luminance has a negative polarity, the control signal generator controls each multiplexer so that each multiplexer selects a low gray-level voltage from the gray-level voltages received by each multiplexer, and outputs the low gray-level voltage to the digital/analog converter for compensation.

14. The apparatus of compensating gray-level luminance of claim 7, wherein a driving method for the liquid crystal display panel is an N-line inversion driving method in which the polarity of N horizontal lines reverses once, and N is larger than, or equal to 2.

15. A liquid crystal display having an apparatus of compensating a gray-level voltage, comprising:
a liquid crystal display panel, comprising a plurality of data lines and a plurality of horizontal lines perpendicular to the data lines from top to bottom, each data line comprising a plurality of pixels, each pixel corresponding to one of the gray levels, each pixel corresponding to a polarity signal;
a voltage-dividing circuit for receiving and dividing a plurality of gamma voltages to generate a plurality of gray-level voltages corresponding to the luminance of each gray level;
a control signal generator coupled to the data lines, generating a control signal based on a polarity of the data lines;
a plurality of multiplexers coupled to the voltage-dividing circuit and the control signal generator, receiving the control signal and selecting one of the gray-level voltages for compensation based on the control signal; and
a digital/analog converter coupled to the multiplexers, receiving the gray-level voltages output from the multiplexers.

16. The liquid crystal display of claim 15, wherein the voltage-dividing circuit comprises a plurality of voltage-dividing units connected in series, and each voltage-dividing unit is composed of a plurality of passive components.

17. The liquid crystal display of claim 15, wherein the voltage-dividing circuit comprises a plurality of voltage-dividing units connected in series, and each voltage-dividing unit is composed of a plurality of active components.

18. The liquid crystal display of claim 15, wherein a second number of the gray-level voltages corresponding to a first number of the gray levels are generated by multiplying the first number with the second number of voltage-dividing units in series, and each voltage-dividing unit is composed of a plurality of passive components.

19. The liquid crystal display of claim 15, wherein a second number of the gray-level voltages corresponding to a first number of the gray levels are generated by multiplying the first number with the second number of voltage-dividing units in series, and each voltage-dividing unit is composed of a plurality of active components.

20. The liquid crystal display of claim 15, wherein when the pixel corresponding to the gray-level luminance has a positive polarity, the control signal generator controls each multiplexer so that each multiplexer selects a high gray-level voltage from the gray-level voltages received by each multiplexer, and outputs the high gray-level voltage to the digital/analog converter for compensation.

21. The liquid crystal display of claim 15, wherein when the pixel corresponding to the gray-level luminance has a negative polarity, the control signal generator controls each multiplexer so that each multiplexer selects a low gray-level voltage from the gray-level voltages received by each multiplexer, and outputs the low gray-level voltage to the digital/analog converter for compensation.

22. The liquid crystal display of claim 15, wherein a driving method for the liquid crystal display panel is an N-line inversion driving method in which the polarity of N horizontal lines reverses once, and N is larger than, or equal to 2.
